(19) United States
(12) Patent Application Publication
(10) Pub. No.: US 2026/0335802 A1
(43) Pub. Date: Oct. 29, 2026

(54) DIE CUT AIR FILTER FOR TIGHTER HOUSING INTERFACE

(71) Applicant: Amcrest Global Holdings Limited, Dublin (IE)

(72) Inventor: Abdurahman RAVAT, Houston, TX (US)

(21) Appl. No.: 19/189,114

(22) Filed: Apr. 24, 2025

(51) Int. Cl. B01D 46/00; B01D 46/52

(52) U.S. Cl. CPC B01D 46/0005; B01D 46/0032; B01D 46/521; B01D 2265/028; B01D 2279/50; B01D 2279/65

(57) ABSTRACT

Device and method for a die-cut air filter configured for use in an HVAC air filtration system includes an air filter frame defining on front and back sides a trellis for allowing air flow through air filtering material contained therein. Along top and bottom sides, air filter frame is provided with cut-outs that extend along both top and bottom side of air filter frame and along both front and back sides. When placed inside a housing, with top or bottom surface of the filter facing out, the cut-outs are configured to receive tension clips extending from opposing sides of a bottom side of a cover of a housing to create more air tight seal between air filter and housing assembly at the air filter to housing assembly interface to promote more air flow across the air filtering material and minimize air flow at the air filter to housing assembly interface.

### TECHNICAL FIELD

The present invention relates generally to HVAC air filters. More particularly, the present invention relates to an air filter design and system configured to improve air flow.

### BACKGROUND

HVAC refers to heating, ventilating, and air conditioning. HVAC equipment refers to systems and technologies used to control the temperature, humidity and quality of air. An HVAC heater will increase temperature using furnaces or heat pumps; an HVAC ventilator will exchange indoor air with air outside; and an air conditioner will reduce the temperature and humidity of the air, typically using air conditioners or heat pumps.

An HVAC air filter, also referred to as a furnace or AC filter is a device used to trap dust, pollen, pet dander, and other pollutants before the air enters the HVAC system.

HVAC filters are typically placed in the HVAC system's air intake system, where the filters may capture particles as the air passes through them. HVAC air filters are designed to be replaced regularly, typically every 1-3 months depending on the type of filter and level of dust and pollutants in a home.

A die-cut air filter refers to an air filter whose frame or filter material are precisely cut into a desired shape using a die-cutting machine. The process typically uses a metal mold with sharp edges to cut materials like paperboard or plastic. Die cutting may be used to create the frames that hold the filtering material in place, or to cut out specific shapes or patterns in the filter media itself. Die-cut filter frames are commonly made from paperboard or cardboard. The filtering material itself can be from various materials like foam, fabric, or specialized filtration materials.

The filtering material of HVAC filters may be fiberglass, pleated, or HEPA filters. Fiberglass filters are made of layered fiberglass fibers. Pleated fibers are made from cotton or polyester folds and capture more dust and small particles. HEPA filters are high efficiency particulate air filters designed to trap extremely small particles, including bacteria and viruses, making them ideal for homes with allergies or respiratory issues.

HVAC air filters are also given a MERV rating. MERV stands for Minimum Efficiency Reporting Value rating which indicates the effectiveness of the air filter in trapping particles of different sizes. A higher MERV rating means the filter is more efficient at capturing smaller particles.

FIG. 1 shows a prior art two-piece paperboard frame 1 for holding filtering material (not shown). The frame 1 includes a top frame 2 and a bottom frame 22. Top frame 2 includes a diamond shaped trellis 10 with, as an illustration of one of the diamonds in the trellis formed by edges 11, 12, 13, 14 that define an opening 15 of the trellis. Along edges of trellis are side panels 3, 4, 5, 16 that are separated from trellis 10 by score lines 6, 7, 8, 9, respectively. Similarly, the bottom frame 22 includes a diamond shaped trellis 30 with, as an illustration of one of the diamonds in the trellis formed by edges 31, 32, 33, 34 that define an opening 35 of the trellis. Along edges of trellis are side panels 23, 24, 25, 36 that are separated from trellis 10 by score lines 26, 27, 28, 29, respectively.

To make an HVAC air filter the top frame 2 is placed on a front side of a filter material and the bottom frame 22 is place on a back side of a filter medium. Sides panel 23, 24, 25, 36 of bottom frame 22 are folded 90° about the score lines 26, 27, 28, 29, respectively, so that the side panels lie along a side of the filter medium, Sides panel 3, 4, 5, 16 of top frame 2 are folded 90° about the score lines 6, 7, 8, 9, respectively, so that the side panels lie above sides panel 23, 24, 25, 36, respectively. A biofriendly industrial adhesive is applied between the side panels of the top and bottom frames 2, 22 to hold the top and bottom frames together about the filter material to form the HVAC air filter.

HVAC air filters are placed in a frame or container referred to as a housing to form an HVAC air filtration system. The housing holds and secures the air filter in place within the HVAC unit. The HVAC housing functions to provide a secure and airtight seal around the filter, ensuring that air passing through the HVAC system is properly filtered. Air filter housings come in various sizes and depths to accommodate different filtering types and system requirements.

In conventional HVAC air filtration systems the HVAC air filters are loosely slipped into the housing such as to allow some play between the HVAC air filter and the housing. While facilitating the assembly of the HVAC air filtration system, the “play” introduces spaces between the HVAC air filter and the housing along the HVAC air filter housing interface that allows some air flow to bypass the filter medium. The bypassed air flow reduces the efficiency of the HVAC air filtration system by allowing unfiltered airflow to enter a house or a dwelling.

There is a need for an HVAC filter with a tighter interface to HVAC housing and air filtration system.

### SUMMARY

Disclosed is a device and method for a die-cut air filter configured for use in an HVAC air filtration system including an air filter frame defining on front and back sides a trellis for allowing air flow through air filtering material contained in the air filter. Along top and bottom sides, air filter frame is provided with cut-outs that extend along both top side and bottom side of air filter frame and extending along both front and back sides. When placed inside a housing, with top or bottom surface of the filter facing out, the cut-outs are configured to receive tension clips extending from opposing sides of a bottom side of a cover of a housing to create more air tight seal between air filter to housing assembly at the air filter to housing assembly interface so as force more of the air flow across the air filter material and minimize the flow of air at the air filter to housing assembly interface.

### BRIEF DESCRIPTION OF THE DRAWINGS

FIG. 1 depicts front and back sides of a prior art die cut air filter;

FIG. 2 is a front perspective view of the air filter of this disclosure;

FIG. 3 is a front side view of the air filter of FIG. 2;

FIG. 4 is a top side view of the air filter of FIG. 2;

FIG. 5 is a back side view of the air filter of FIG. 2;

FIG. 6 is a bottom side view of the air filter of FIG. 2;

FIG. 7 is FIG. 3 showing panels of the air filter of FIG. 3 prior to assembly;

FIG. 8 is FIG. 5 showing panels of the air filter of FIG. 4 prior to assembly;

FIG. 9 is a right side view of the air filter of FIG. 2;

FIG. 10 is a left side view of the air filter of FIG. 2;

FIG. 11 is an illustrative housing assembly with housing and cover for use with the air filter of FIG. 2;

FIG. 12 is a bottom side view of the cover of FIG. 11;

FIG. 13 is a top elevation view of the housing of FIG. 11;

FIG. 14 shows from front side 211 of air filter of FIG. 2, the air filter inserted into the housing of FIG. 13;

FIG. 15 shows from front side 211 of the insertion of FIG. 14 with the air filter fully inserted;

FIG. 16 shows from front side 211 of the cover of FIG. 12 being connected to the housing of FIG. 13;

FIG. 17 shows from front side 211 of an advancement of the act of connecting shown in FIG. 16;

FIG. 18 shows from back side 215 of a further advancement of the act of the connecting shown in FIG. 16;

FIG. 19 shows from back side 215 of a further advancement of the act of the connecting shown in FIG. 16;

FIG. 20 shows from back side 215 of a further advancement of the act of the connecting shown in FIG. 16;

FIG. 21 shows from back side 215 of a further advancement of the act of the connecting shown in FIG. 16;

FIG. 22 shows FIG. 11 housing with air filter of this disclosure inserted therein and secured by the cover;

FIG. 23 shows tension clips extending from sides of a back side of cover of FIG. 12 for providing tight air filter to housing interface of this disclosure with the drawing taken along plane A-A in FIG. 19;

FIG. 24 shows flanges extending from a back side of cover of FIG. 12 for providing tight air filter to housing interface of this disclosure with the drawing taken along plane A-A in FIG. 17;

FIG. 25 is the FIG. 3 showing cut-out dimensions and positioning along the front side of air filter frame 41;

FIG. 26 is FIG. 4 showing cut-out dimensions and positioning along the top side of air filter frame 41;

FIGS. 27-30 present a method for making a die cut HVAC filter 40 according to this disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

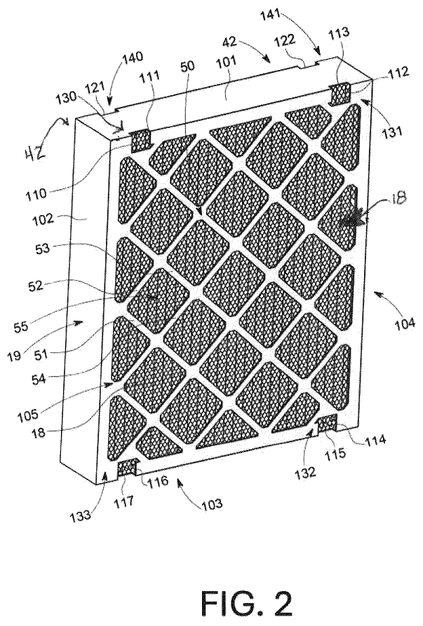

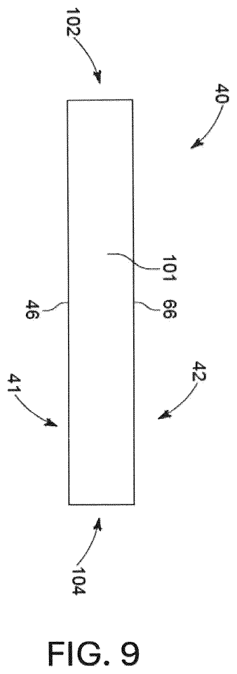

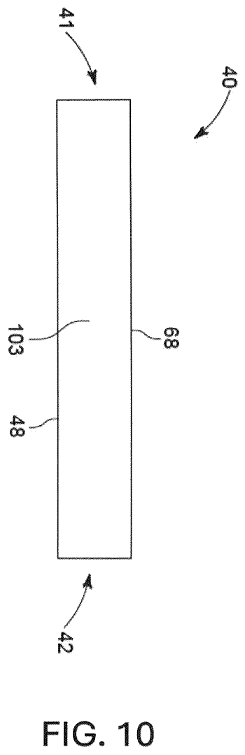

FIGS. 2-10 depict an air filter 40 in accordance with this disclosure.

FIG. 2 depicts air filter 40 in perspective. Air filter 40 is a “die-cut air filter”, that is, an air filter frame 19 and/or air filtering material 18 that is precisely cut into a desired shape using a die-cutting machine, a process that uses sharp dies to cut shapes from various materials. The air filter frame 19 is designed to receive and hold air filtering material 18.

Air filter 40 is illustratively an HVAC air filter and filtering material 18 may be pleated fibers. Illustratively, filtering material 18 may be a synthetic electrostatically charged air filter media. It will be appreciated that filtering material 18 may be fiberglass, pleated, or HEPA filters. Fiberglass filters are made of layered fiberglass fibers. Pleated fibers are made from cotton or polyester folds and capture more dust and small particles. HEPA filters are high efficiency particulate air filters designed to trap extremely small particles, including bacteria and viruses, making them ideal for homes with allergies or respiratory issues.

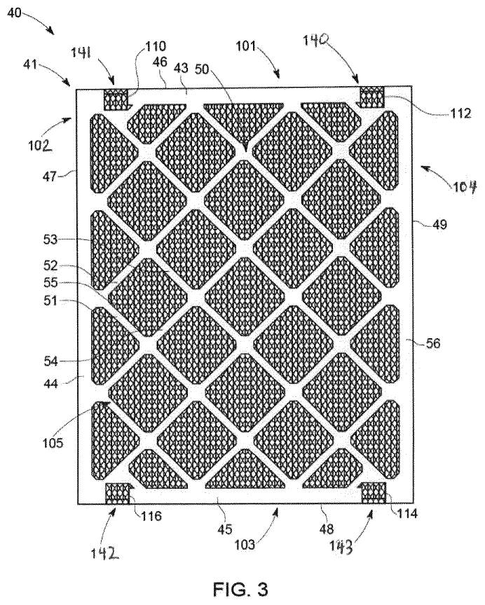

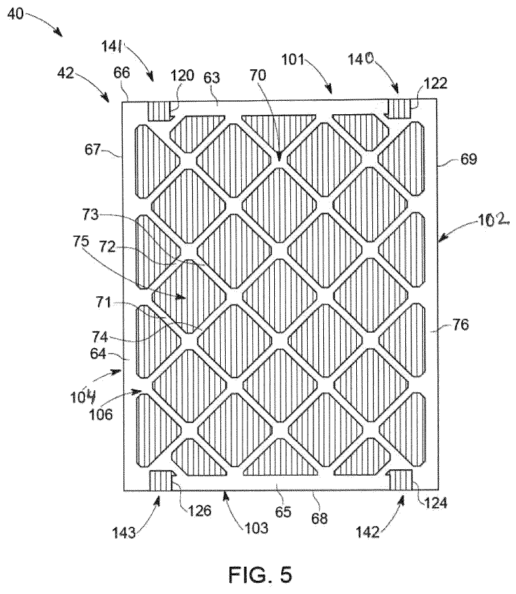

Air filter frame 19 of air filter 40 includes a top side 101, a bottom side 103, a right side 102, a left side 104, a front side 41 (FIG. 3), and a back side 42 (FIG. 5).

Both front side 41 and back side 42 of air filter 40 define a trellis 105, 106 (FIGS. 3 and 5), respectively, of diamond shaped openings, one diamond shaped opening 55, 75, of which is illustratively shown in FIGS. 3 and 5 as having sides 51/52/53/54 and sides 71/72/73/74, respectively. The diamond shaped opening formed in the trellis allows air flow through the openings of the trellis (e.g., 55,75), and across the filtering material 18 in an HVAC air filtration system.

As shown in FIGS. 2, 3, 5, along top side 101, air filter frame 19 is provided with first, second, third, and fourth cut-outs 130, 131, 140, 141, respectively. First and second cut-outs 130, 131 extend along right side and left side of air filter frame 19, respectively, along both top side 101 and front side 41 of air filter frame 19. Third and Fourth cut-outs 140, 141 extend along right side and left side of air filter frame 19, respectively along both top side 101 and back side 42 of air filter frame 19.

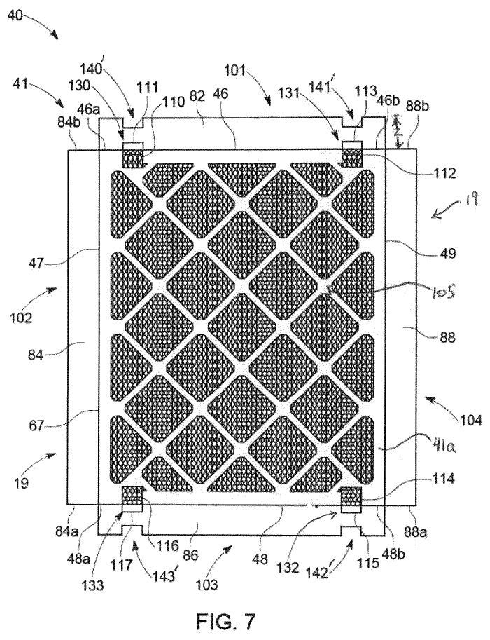

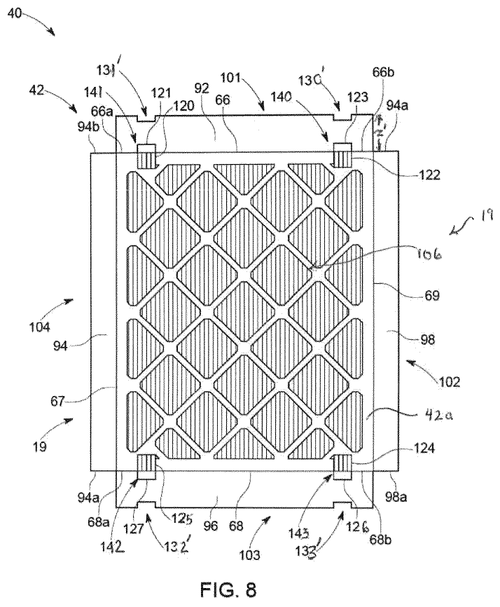

As shown in the die-cuts of air filter 40 in FIGS. 7, 8, first cut-out 130 comprises a cut-out section 110 along front side 41 of filter frame 19 and cut-out section 111 along top side 101 of filter frame 19. Second cut-out 131 comprises a cut-out section 112 along front side 41 of filter frame 19 and cut-out section 113 along top side 101 of filter frame 19. Third cut-out 140 comprises a cut-out section 122 along back side 42 of filter frame 19 and cut-out section 123 along top side 101 of filter frame 19. Fourth cut-out 141 comprises a cut-out section 120 along back side 42 of filter frame 19 and cut-out section 121 along top side 101 of filter frame 19.

As also shown in FIGS. 2, 3, 5, along bottom side 103, air filter frame 19 is provided with first, second, third, and fourth cut-outs 133, 132, 143, 142, respectively. First and second cut-outs 133, 132 extend along right side and left side of air filter frame 19, respectively, along both bottom side 103 and front side 41 of air filter frame 19. Third and fourth cut-outs 143, 142 extend along right side and left side of air filter frame 19, respectively, along both bottom side 103 and back side 42 of air filter frame 19.

As shown in the die-cuts of air filter 40 in FIGS. 7, 8, first cut-out 133 comprises a cut-out section 116 along front side of filter frame 19 and cut-out section 117 along bottom side 103 of filter frame 19. Second cut-out 132 comprises a cut-out section 114 along front side of filter frame 19 and cut-out section 115 along bottom side 103 of filter frame 19. Third cut-out 143 comprises a cut-out section 124 along back side 103 of filter frame 19 and cut-out section 126 along bottom side 103 of filter frame 19. Fourth cut-out 142 comprises a cut-out section 125 along back side 103 of filter frame 19 and cut-out section 127 along bottom side 103 of filter frame 19.

A fifth and a sixth cut-out 140′, 141′ on top surface 101 of front side 41 mirrors third and fourth cut-out 140, 141, respectively, on top surface 101 of back side 42 of filter frame 19. A seventh and an eight cut-out 143′, 142′ on bottom surface 103 of front side 41 mirrors third and fourth cut-out 143, 142, respectively, on bottom surface 103 of back side 42 of filter frame 19.

A fifth and a sixth cut-out 131′, 130′ on top surface 101 of back side 42 mirrors 1st and second cut-out 131, 130, respectively, on top surface 101 of front side 41 of filter frame 19. A seventh and an eight cut-out 132′, 133′ on bottom surface 103 of back side 42 mirrors third and fourth cut-out 132, 133, respectively, on bottom surface 103 of front side 41 of filter frame 19.

As depicted in FIG. 7, filter frame 19 along front side 41 of air filter frame 19 is provided with score line 46 between front side panel 41a of front side 41 and top panel 82; score line 47 between front side panel 41a of front side 41 and right side panel 84; score line 48 between front side panel 41a of front side 41 and bottom panel 86; and score line 49 between front side panel 41a of front side 41 and left side panel 88. Score lines 46, 47, 48, 49 permit panels 82, 84, 86, and 88 to be folded toward the back side 42 of the air filter 40 for assembly of the air filter frame 19.

As depicted in FIG. 8, filter frame 19 along back side 42 of air filter frame 19 is provided with score line 66 between back side panel 42a of back side 42 and top panel 82; score line 67 between back side panel 42a of back side 42 and left side panel 94; score line 68 between back side panel 42a of back side 42 and bottom panel 96; and score line 69 between back side panel 42a of back side 42 and right side panel 98. Score lines 66, 67, 68, 69 permit panels 92, 94, 96, and 98 to be folded toward the front side 41 of the air filter 40 for assembly of the air filter frame 19.

The area within the score lines of the die cut for the front side 41 of air filter 40 is dimensioned to be marginally larger than the dimensions of the die cut for the back side 42 of air filter 40. This allows panels 88, 82, 84, 86 to overlay panels 98, 92, 94, 96 when front side 41 and back side 42 of the filter 40 are brought together. In addition, each of front side 41 and back side 42 is die cut to have an inside and an outside surface.

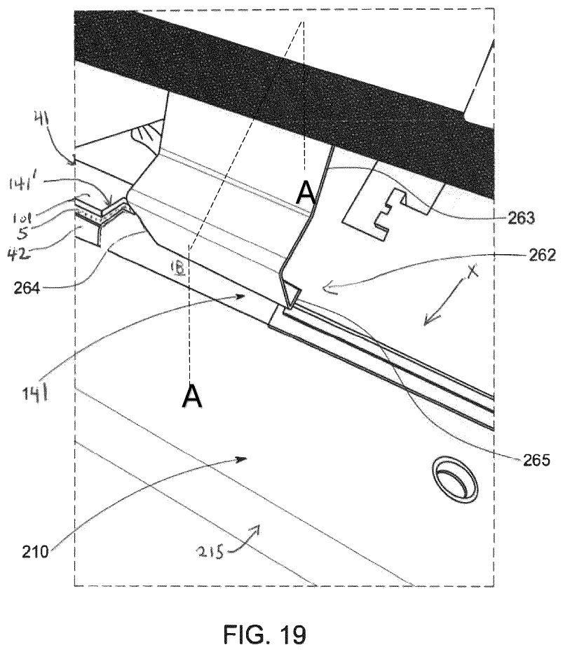

To assemble, front side 41 of air filter frame 19, back side 42 of air filter frame, and air filtering material 18 are die cut to the dimensions designed for air filter 40. The outside surface of back side 42 of air filter frame 19 is placed against a work surface. Air filtering material 18 is placed on top of the inside surface of back side 42. The inside surface of front side 41 of air filter frame 19 is placed over air filtering material 18 atop back side 42 of air filter frame 19. Panels 92, 94, 96, and 98 on back side 42 are folded about the filtering material 18 along score lines 66, 67, 68, 69, respectively, toward the front side 41 of the air filter 40. Panels 82, 84, 86, and 88 on front side 41 are folded about the filtering material 18 along score lines 46, 47, 48, 49, respectively, toward the toward the back side 42 of the air filter 40 to sit atop panels 92, 94, 96, and 98 of the back side 42 of the air filter 40. An adhesive 5 (shown in FIG. 19) placed between panels 82, 84, 86, 88 and panels 92, 94, 96, 98, respectively where they adjoin holds the back side 42 of the air filter 40 to the front side of the air filter 40 to form air filter 40 for use with HVAC equipment of this disclosure.

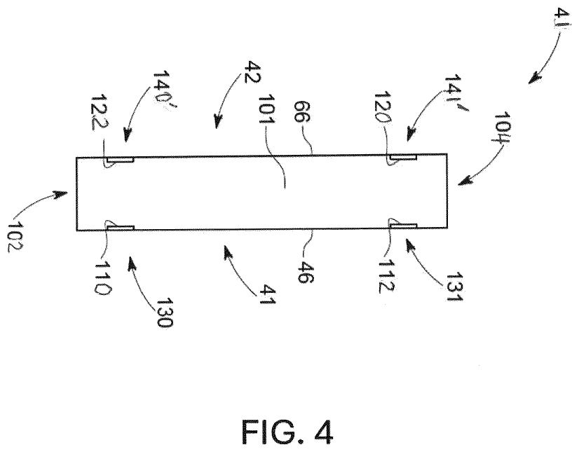

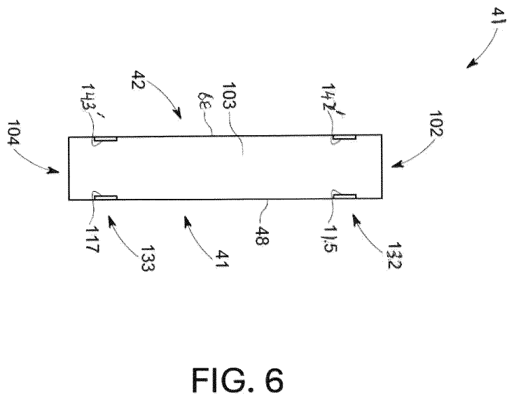

FIG. 4 shows top planer view of air filter 40 depicting top panel 101 oriented in accordance with front side 41 and back side 42 and right side 102 and left side 104. As shown in FIG. 4, the fifth and a sixth cut-out 140′, 141′ on top surface 101 of front side 41 which mirrors third and fourth cut-out 140, 141, respectively, on top surface 101 of back side 42 of filter frame 19 sits atop third and fourth cut-out 140, 141, respectfully, on top surface 101 of back side 42 of the filter frame 19 once assembled. As shown in FIG. 6, the seventh and the eight cut-out 143′, 142′ on bottom surface 103 of front side 41 which mirrors third and fourth cut-out 143, 142, respectively, on top surface 101 of back side 42 of filter frame 19 sits atop third and fourth cut-out 143, 142, respectfully, on bottom surface 103 of back side 42 of the filter frame 19 once assembled.

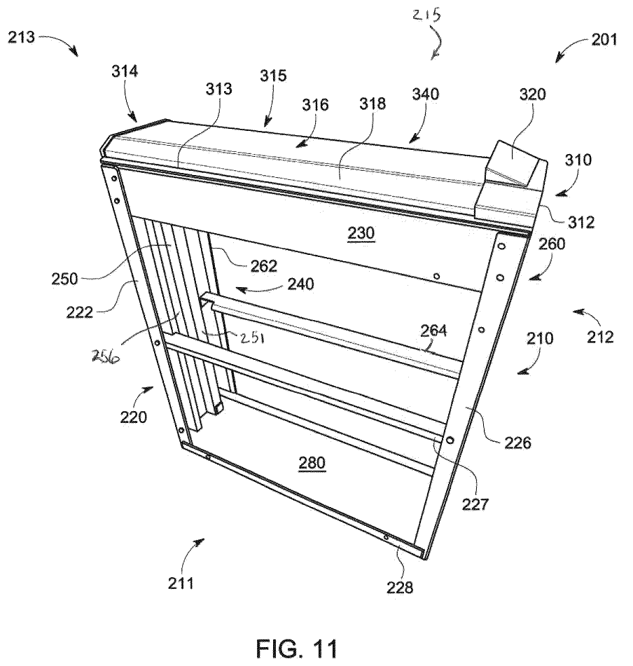

FIG. 11 depicts a housing assembly 201 for receiving air filter 40 of this disclosure with orientation shown as right side 213, left side 212, front side 211 and back side 215. Housing assembly 201 includes a housing 210 and a cover 310.

Housing 210 includes a front side support structure 220, a back side support structure 240, a right wall structure 250 and a left wall structure 260. Front side support structure 220 includes uprights 222, 224 which are tied together using a horizontal bars 227, 228 and horizontal plate 230. Back side support structure 260 includes similar structure albeit only upright 262 and horizontal bar 264 are depicted in the FIG. Right wall structure 250 and left wall structure 260 are vertical structures. Housing 210 may also include a base plate 280. The components for the foregoing structure may be made from steel or any other material that is of sufficient structure and meets the design requirement for use in an HVAC air filtration system.

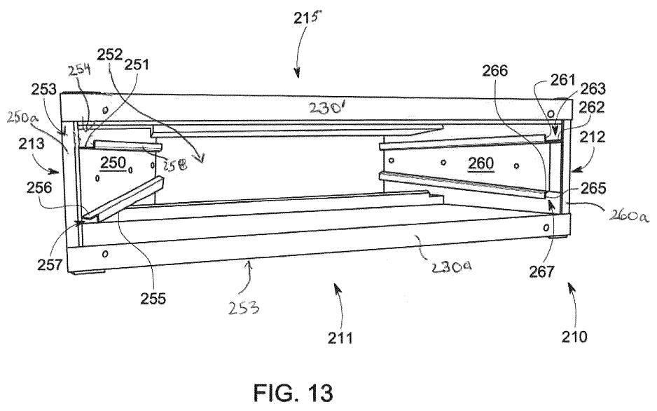

As shown in FIG. 13, a top surface 230a of horizontal plate 230, a similar top surface 230′ of a horizontal plate running back side of housing 210, a top surface 250a of a housing wall supporting right wall structure 250 and a similar top surface 260a of a housing wall supporting left wall structure 260 running along the side of housing 210 opposite wall structure 250 form a lip 253 defining an opening 252 for receiving air filter 40 of this disclosure. FIG. 13 further shows right wall structure 250 defines flanges 254, 257. Flange 254 forms a sidewall 251 with a horizontal extender 258. Flange 257 forms a sidewall 256 with a horizontal extender 255. The sidewalls 251, 256 hold the right side of air filter 40 inside housing 220 when air filter 40 is placed inside housing 210. Similarly, sidewalls 262, 266 with horizontal extenders 261, 266, respectively, of flanges 263, 267, respectively, hold the left side of air filter 40 inside housing 220 when air filter 40 is placed inside housing 210.

FIG. 11 shows top side 340 of cover 310 with orientation shown as right side 212, left side 213, front side 211 and back side 215. Top side 340 of cover 310 comprises a front side 318, a back side 315, a right wall structure 314, and a left wall structure 312. Along a top part, cover 310 further includes a top surface 316. A contour surface 318 on one or both or other sides along top of cover 310 allow for easier holding by the hand of a user when positioning cover 310 to sit atop lip 253 to cover opening 252 of housing 210.

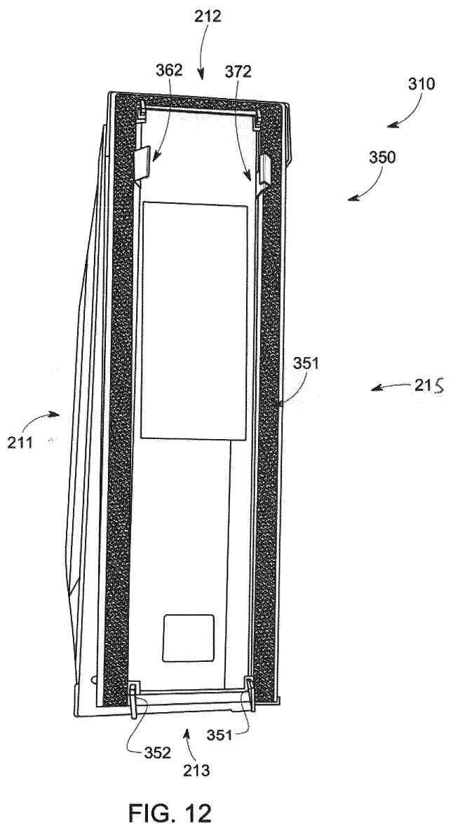

FIG. 12 shows bottom side 350 of cover 310 comprising a pair of flanges 351, 352 and a pair of tension clips 362, 372. Flange 352 is defined on right side 212 of cover 350 near the front side 211 of cover 310. Flange 362 is defined on left side 211 of cover near the back end 215 of cover 310. Tension clip 362 is defined on right side 212 of cover 350 near front side 211 of cover 310. Tension clip 372 is defined on right side 212 of cover 350 near back side 214 of cover 310.

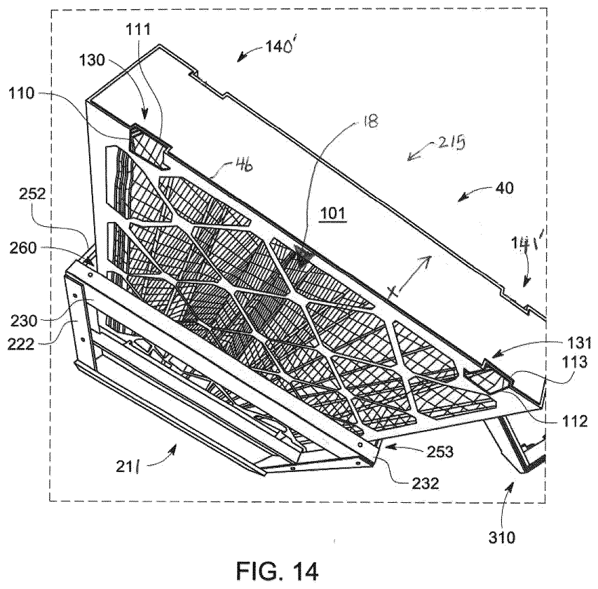

FIG. 14 shows from front side 211 of air filter of FIG. 2, the air filter inserted into the housing of FIG. 13. FIG. 14 shows air filter 40 of this disclosure slipping into opening 252 of housing 210. The air filter 40 is inserted so that the flow of air is in the direction X since air filter 40 is designed with filter medium 18 to flow in one direction. This means that the flow of air through air filter 40 will be from front side 211 of housing 210 to back side of housing 2.

As shown in FIG. 14, cut-outs 130, 140′ are defined on the top side 101 of the front side 41 of air filter 40 with cut-outs 130, 140′ sitting atop cut-outs 130′ and 140 of the top side 101 of the bottom side 42 of air filter 40 and cut-outs 131, 141′ are defined on the top side 101 of the front side 41 of air filter 40 with cut-outs 131, 141′ sitting atop cut-outs 131′ and 141 of the bottom side 42 of air filter 40.

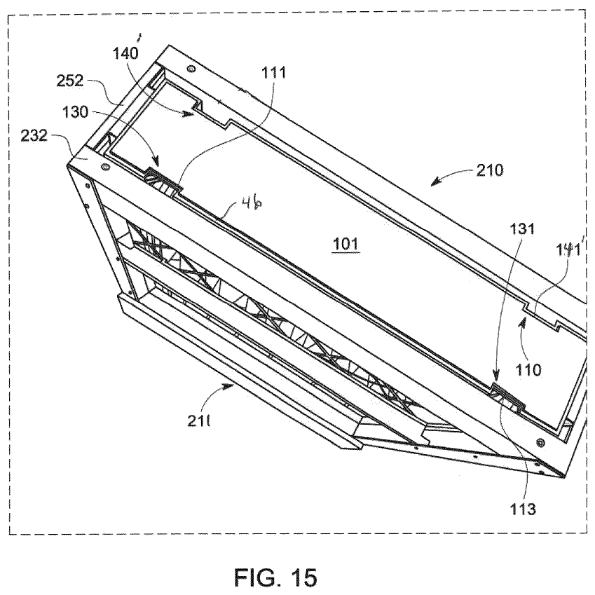

FIG. 15 shows from front side 211 of the insertion of FIG. 14 with the air filter fully inserted. FIG. 15 shows air filter 40 fully seated into opening 252 of housing.

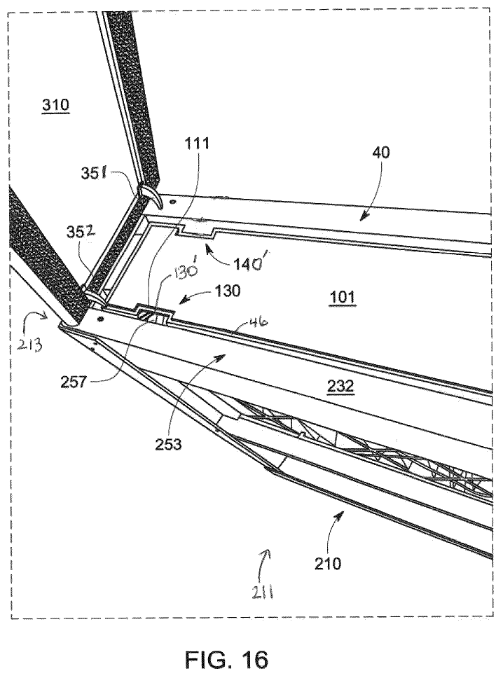

FIG. 16 shows from front side 211 of the cover of FIG. 12 being connected to the housing of FIG. 13. FIG. 16 shows cover 310 being positioned onto lip 253 of housing 210. As depicted, flanges 352, 351 are configured to slip alongside the air filter 40. This allows flanges 352, 351 to firmly hold air filter 40 to right side 213 of housing 210.

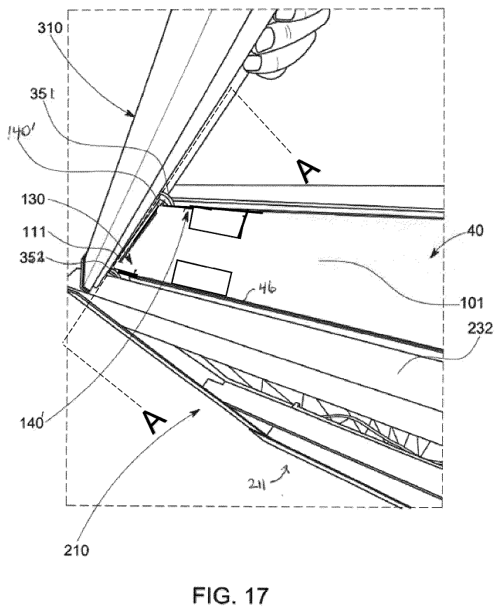

FIG. 17 shows from front side 211 of an advancement of the act of connecting shown in FIG. 16. FIG. 17 shows flanges 354, 352 slipping alongside air filter 40.

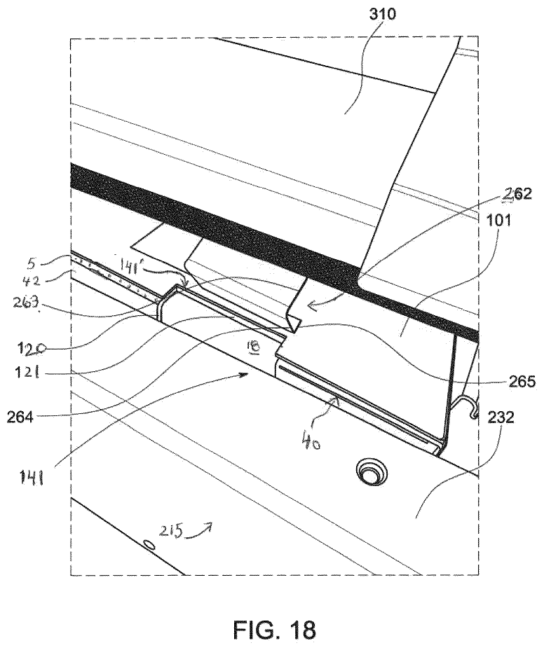

FIG. 18 shows from back side 215 of a further advancement of the act of the connecting shown in FIG. 16. FIG. 18 depicts tension clip 262 (i.e., tension clip 362 in FIG. 12) of cover 310 approaching cut-out 141′ on the top side 101 of the top side 41 of air filter 40 which sits atop cut-out 141 on the top side 101 of the bottom side 42 of air filter 40. Tension clip 262 (i.e., tension clip 362 in FIG. 12) has a vertical member 263, angulating member 264 angulating inwardly toward the vertical member 263, and an end member 265. Angulating member 264 creates inward tension of the end member 265 against air filter 40 once angulating member 264 comes to a full stop within housing 210 on completion of the insertion of air filter 40 into housing 201.

FIG. 19 shows from back side 215 of a further advancement of the act of the connecting shown in FIG. 16. FIG. 19 shows FIG. 18 wherein tension clip 262 (i.e., tension clip 362 in FIG. 12) is almost in alignment with cut-out 131. Inserted end member 265 is seen ready to pass through cut-out 141′ on top side 101 of front side 41 of air filter 40 which sits atop and through which end member 265 will also pass cut-out 141 on top side 101 of back side 41 of air filter. As described further below, tension clip 262 (i.e., tension clip 362 in FIG. 12) is configured to slip through cut-outs 41′ and 41 and come to a stop once past the cut-outs so as to firmly hold air filter 40 to left side 215 of housing 210.

Advantageously, cut-outs 130, 131, 132, 133 on the front side 41 of air filter 40 and cut-outs 140, 141, 142, 143 on the bottom side 42 of air filter 40 and their respective analog cut-outs (e.g., cut-out 130′ on back side 42 analog to cut-out 130 on front side 41 of air filter 40) are available for receipt of tension clips 362, 372 depicted in FIG. 12. As a result, air filter 40 may be inserted into housing 210 in either top side 101 first into housing 210 direction or bottom side 103 first into housing 210 direction. As previously described in connection with FIG. 14, the flow of air through air filter 40 is designed to be in direction X. In the illustrative embodiment above described, this means that cut-outs 131 and 141′ of top side 41 will be available to receive tension clips 362, 372 depicted in FIG. 12 when air filter 40 is inserted into housing 210 with the bottom side 103 first into the housing 210 whereas cut-outs 132, 143′ will be available to receive tension clips 362, 372 depicted in FIG. 12 when air filter 40 is inserted into housing 210 with the top side 101 first into the housing 210. It will be appreciated that the foregoing design of cut-outs on both top side 101 and bottom side 103 of air filter 40 makes possible two alternate ways in which air filter 40 of this disclosure may be adapted to housing 210.

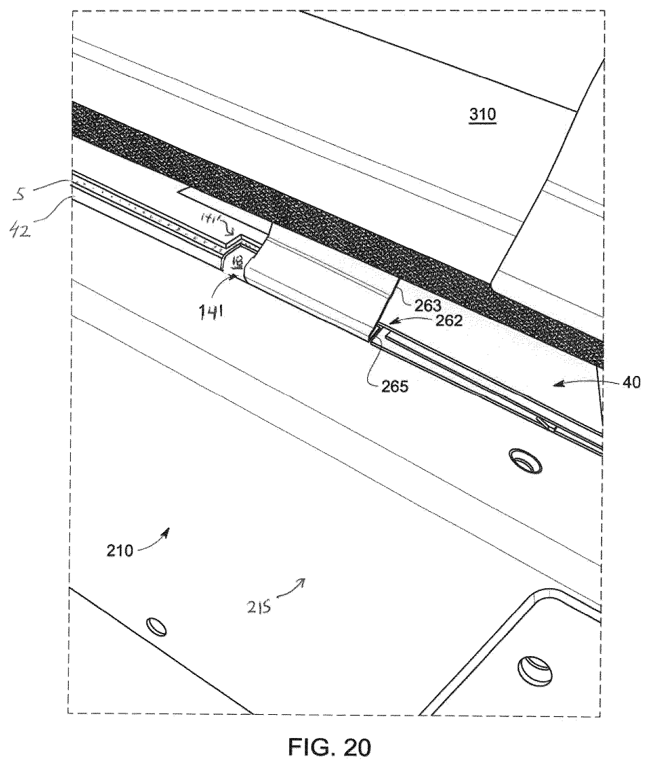

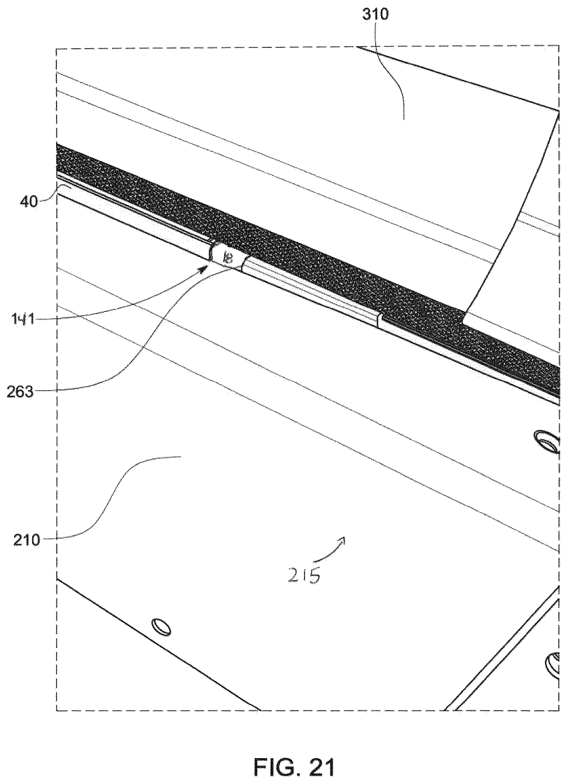

FIGS. 20-21 show still further insertion of tension clip 262 into cut-out 141′. FIG. 20 shows from back side 215 of a further advancement of the act of the connecting shown in FIG. 16.

FIG. 21 shows from back side 215 of a further advancement of the act of the connecting shown in FIG. 16.

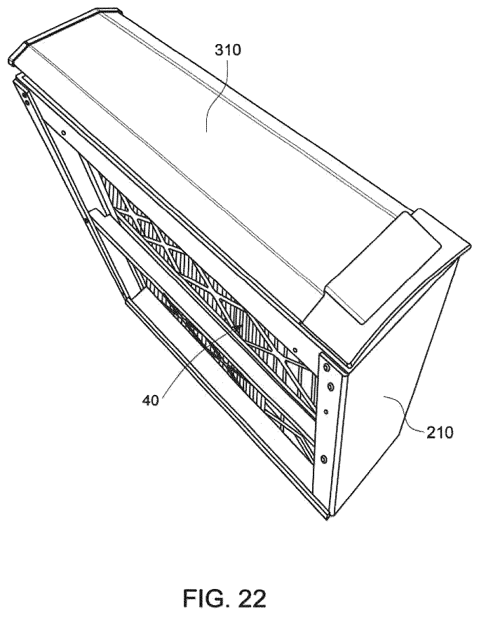

FIG. 22 shows FIG. 11 housing with air filter of this disclosure inserted therein and secured by the cover. FIG. 22 shows filter 40 in housing 210 firmly secured to the housing by the foregoing flanges and slip covers and covered by cover 310 to form the air filtration system of this disclosure.

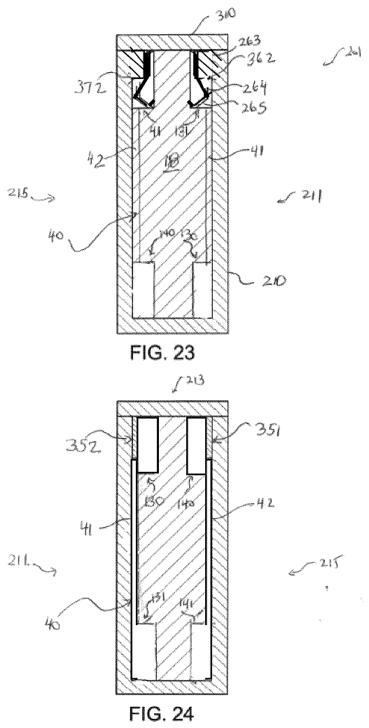

FIGS. 23, 24 show the tight interface created by the air filter 40 of this disclosure with the housing assembly 201. FIG. 23 shows tension clips 362, 372 depicted in FIG. 12 (262,272 in FIGS. 18-21) extending from sides of a back side of cover of FIG. 12 for providing tight air filter to housing interface of this disclosure.

FIG. 24 shows flanges extending from a back side of cover of FIG. 12 for providing tight air filter to housing interface of this disclosure.

In FIG. 23, housing assembly 201 applies a tension force to pair of tension clips 362, 372 depicted in FIG. 12 (262,272 in FIGS. 18-21) on housing assembly 210 so as to force tension clips 362, 372 against front and back side of air filter 40 of this disclosure. In so doing, tension clips 362, 372 apply a force laterally across front side 41 and back side 42 of air filter 40, effectively clamping the sides of air filter 40 to housing assembly 210 so as to keep air filter 40 from moving laterally within housing assembly 201.

In FIG. 24, housing assembly 201 applies a tension force to pair of flanges 351, 352 on housing assembly 210 so as to force flanges 351 ,351 against front side 211 and back side 215 of air filter 40 of this disclosure. In so doing, flanges 351, 352 apply a force laterally across front side and back side of air filter 40, effectively pressing the front and back sides of air filter 40 to housing assembly 201 so as to keep air filter 40 from moving laterally within housing assembly 201. In other words, flanges 351, 352 hold sides of air filter 40 rigidly against front side 211 and back side 215 of housing 210.

There is thus disclosed an HVAC filter 40 including an air filter frame and air filtering material contained therein, the air filter frame comprising:
a top side 101, a bottom side 103, a right side 102, a left side 104, a front side 41, and a back side 42, both front side 41 and back side 42 of air filter 40 defining a trellis, respectively, of shaped openings, the shaped openings formed in the trellis allowing air flow through the openings of the trellis, and across the filtering material;
wherein, along top side 101 of front side 41 of air filter 40, front side of air filter frame 19 is provided with a first, a second, a third, and a fourth cut-out 130, 131, 140, 141, respectively; the first and the second cut-outs 130, 131 extending along right side and left side of air filter frame 19, respectively, along both top side 101 and front side 41 of air filter frame 19; and the third and the fourth cut-out 140, 141 extending along right side and left side of air filter frame 19, respectively along both top side 101 and back side 42 of air filter frame 19;
wherein, along bottom side 103, air filter frame 19 is provided with first, second, third, and fourth cut-outs 133, 132, 143, 142, respectively; the first and second cut-outs 133, 132 extending along right side and left side of air filter frame 19, respectively, along both bottom side 103 and front side 41 of air filter frame 19; and third and fourth cut-outs 143, 142 extending along left side and right side of air filter frame 19, respectively, along both bottom side 103 and back side 42 of air filter frame 19.
wherein, both top side and bottom side of air filter frame are configured to be insertable in a housing of an HVAC air filtration system;
wherein the first, the second, the third, and the fourth cut-outs of the top side or the bottom side of air filter frame, whichever is facing outward, is configured to receive a tension clip associated with the housing for the purpose of pressing the filter against the housing so as to provide a tight interface between air filter frame and housing.

The HVAC filter 40 including an air filter frame and air filtering material contained therein may further feature, wherein the first cut-out 130 comprises a cut-out section 110 along front side 41 of filter frame 19 and cut-out section 111 along top side 101 of filter frame 19, the second cut-out 131 comprises a cut-out section 112 along front side 41 of filter frame 19 and cut-out section 113 along top side 101 of filter frame 19, the third cut-out 140 comprises a cut-out section 120 along front side 41 of filter frame 19 and cut-out section 121 along back side 42 of filter frame 19, and the fourth cut-out 141 comprises a cut-out section 122 along front side of filter frame 19 and cut-out section 123 along back side 42 of filter frame 19.

In an embodiment, the HVAC filter 40 including an air filter frame and air filtering material contained therein may further feature, wherein the first cut-out 133 comprises a cut-out section 116 along front side of filter frame 19 and cut-out section 117 along bottom side 103 of filter frame 19, the second cut-out 132 comprises a cut-out section 114 along front side of filter frame 19 and cut-out section 115 along bottom side 103 of filter frame 19, the third cut-out 143 comprises a cut-out section 126 along front side of filter frame 19 and cut-out section 127 along bottom side 103 of filter frame 19; and the fourth cut-out 142 comprises a cut-out section 124 along back side 103 of filter frame 19 and cut-out section 125 along bottom side 103 of filter frame 19.

The HVAC filter 40 including an air filter frame and air filtering material contained therein may further feature, wherein, if when placed in a housing with bottom surface facing out, cut-outs 134, 142 are configured to receive tension clips 262, 372 extending from opposing sides of a bottom side of a cover of a housing.

In an embodiment, The HVAC filter 40 including an air filter frame and air filtering material contained therein may be used in combination with a housing assembly.

In an embodiment, the HVAC filter 40 including an air filter frame and air filtering material contained therein may further feature, wherein the housing assembly includes a cover 310, a bottom side 350 of cover 310 comprising a pair of flanges 352,354 and a pair of tension clips 362, 372; wherein, flange 352 is defined on right side 213 near the front end 211 of cover 310 and flange 362 is defined on left side 211 near the back end 214 of cover 310; wherein, tension clip 362 is defined on left side 212 near front end 211 of cover 310 and flange 372 is defined on left side 212 near back end 213 of cover 310.

In an embodiment, the HVAC filter 40 including an air filter frame and air filtering material contained therein may further feature, wherein with air filter 40 inserted into the housing assembly 201 the housing assembly applies a tension force to pair of tension clips 362, 372 on housing assembly 210 so as to force tension clips against left and right side of air filter 40 to clamp the sides of air filter 40 to housing assembly 210 so as to keep air filter 40 from moving laterally within housing assembly 201.

Air filter 40 of this disclosure is illustratively an HVAC air filter and filtering material 18 is illustratively a synthetic electrostatically charged air filter media. Commercially available BNX TruFilter is illustrative. Air filter frame 41 may be any standard or other size die-cut filter frame. The air filter frame 41 may be ½ inch, 1 inch, 2 inches, 4 inches, 5 inches or of custom thickness. The MERV rating may be 8, 11, 13 or other MERV rating. The height and width of the air filter frame 41. Air filter frame 41 may be of any nominal width, height and depth size sufficient for receipt by the air intake housing of an air filtration system. In an illustrative embodiment, a BNX Trufilter of actual size of 20-½ inches×25- 3/16 inches×4 inches yielding an air filter frame of 20 width×25 height×4 inches depth nominal size may be used.

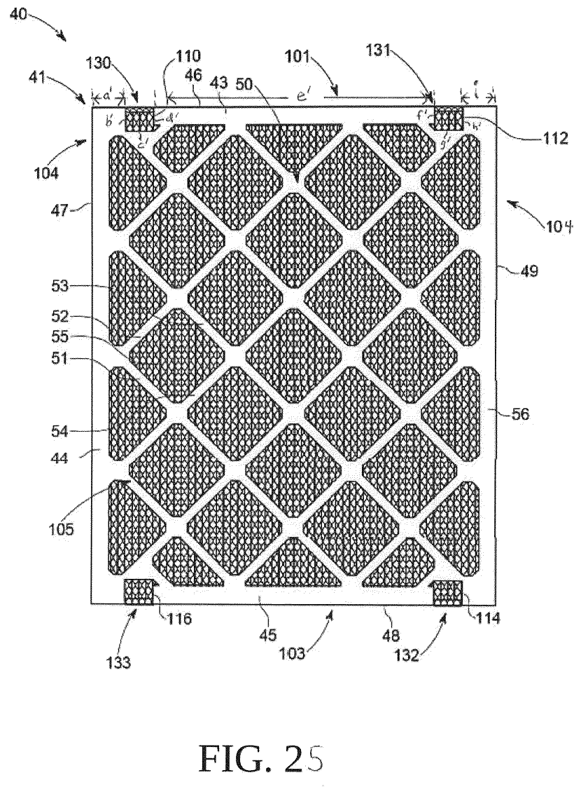

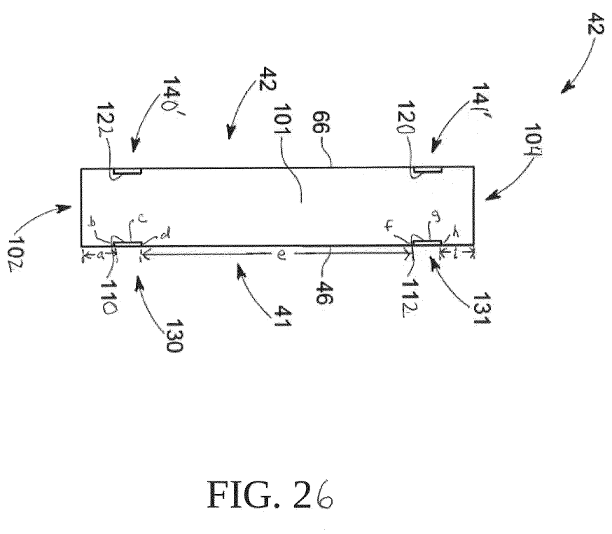

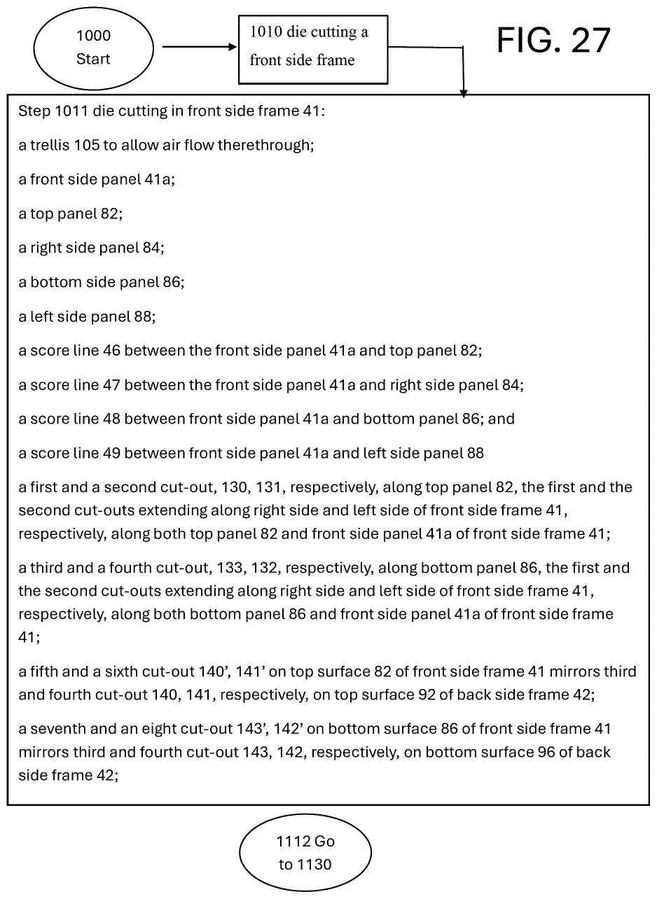

FIG. 25 is the FIG. 3 showing cut-out dimensions and positioning along the front side of air filter frame 41. FIG. 26 is FIG. 4 showing cut-out dimensions and positioning along the front side of air filter frame 41. FIGS. 25, 26 depict illustrative embodiment for cut-outs.

FIG. 25 is the FIG. 3 front side of air filter frame 41 showing cut-out dimensions and positioning along the front side of air filter frame 41. Cut-outs 130, 131 have vertical sides b′, d′ and f′, h′, respectively, of approximately ¾″ in length and lower horizontal side c′ and g′, respectively, of about 1- 6/16″. Cut-outs 130, 131 are each set-in in a′, I′ by about 1- 12/16″ from their respective sides of filter frame 41 and cut-outs 130, 131 are separated from each other by about 14-¼″. Cut-outs for front side of air filter frame 41 may be similarly constructed and dimensioned.

FIG. 26 is the FIG. 4 top side of air filter 40 showing cut-out dimensions and positioning along the air filter 40. Cut-outs 110, 131 have vertical sides b, d and f, h, respectively, of approximately ¼″ in length and upper horizontal side c and g, respectively, of about 1- 6/16″. Cut-outs 110, 131 are each set in a, i by about 1- 12/16″ from their respective sides of filter frame 41 and cut-outs 111, 113 are separated from each other by about 14-¼″.

It will be appreciated that other dimensions may be used for the cut-outs and positioning along the air filter frame depending on air filter dimensions and dimensions of the housing receiving the air filter. It will be appreciated that the dimensions of the cut-outs and positioning may also depend on the tension clips arranged on the cover of the housing. For instance, the cut-outs for receiving the tension clips may be positioned closer to the near side or to the far side of the air filter frame in order to receive the tension clips that are so positioned on the cover of the housing.

In addition while the tension clips and flanges have been described as illustrated in the disclosure above, it will be appreciated that equivalents to the tension clips and flanges may also be used and may be arranged on the housing assembly in a fashion that performs the same function in the same way to perform the same result as the tension clips and flanges on the cover of the housing assembly. For instance, the tension clip may be attached to the housing in a way that attaches to the cover as the cover is placed over the opening of the housing such that the cover pushes the extending end of the tension clips into the cut-out of this disclosure while securing the cover to the housing to accomplish the tight air filter to housing interface taught herein. The flanges may also be so configured.

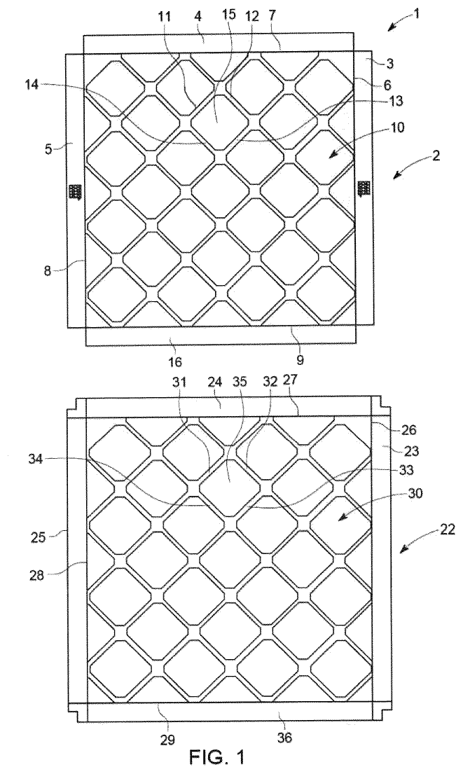

There is thus disclosed in FIGS. 1-26 an HVAC filter 40 including an air filter frame and air filtering material contained therein, the air filter frame including: a top side 101, a bottom side 103, a right side 102, a left side 104, a front side 41, and a back side 42, both front side 41 and back side 42 of air filter 40 defining a trellis, respectively, of shaped openings, the shaped openings formed in the trellis allowing air flow through the openings of the trellis, and across the filtering material. Along top side 101 of front side 41 of air filter 40, front side of air filter frame 19 is provided with a first, a second, a third, and a fourth cut-out 130, 131, 140, 141, respectively. The first and the second cut-outs 130, 131 extending along right side and left side of air filter frame 19, respectively, along both top side 101 and front side 41 of air filter frame 19. The third and the fourth cut-out 140, 141 extending along right side and left side of air filter frame 19, respectively along both top side 101 and back side 42 of air filter frame 19. Along bottom side 103, air filter frame 19 is provided with first, second, third, and fourth cut-outs 133, 132, 143, 142, respectively; the first and second cut-outs 133, 132 extending along right side and left side of air filter frame 19, respectively, along both bottom side 103 and front side 41 of air filter frame 19; and third and fourth cut-outs 143, 142 extending along left side and right side of air filter frame 19, respectively, along both bottom side 103 and back side 42 of air filter frame 19. Both top side and bottom side of air filter frame are configured to be insertable in a housing of an HVAC air filtration system. The first, the second, the third, and the fourth cut-outs of the top side or the bottom side of air filter frame, whichever is facing outward, is configured to receive a tension clip associated with the housing for the purpose of pressing the filter against the housing so as to provide a tight interface between air filter frame and housing.

The above HVAC filter 40 including an air filter frame and air filtering material contained therein wherein the first cut-out 130 includes a cut-out section 110 along front side 41 of filter frame 19 and cut-out section 111 along top side 101 of filter frame 19. The second cut-out 131 includes a cut-out section 112 along front side 41 of filter frame 19 and cut-out section 113 along top side 101 of filter frame 19. The third cut-out 140 includes a cut-out section 120 along front side 41 of filter frame 19 and cut-out section 121 along back side 42 of filter frame 19. The fourth cut-out 141 includes a cut-out section 122 along front side of filter frame 19 and cut-out section 123 along back side 42 of filter frame 19.

The above HVAC filter 40 including an air filter frame and air filtering material contained therein wherein the first cut-out 133 includes a cut-out section 116 along front side of filter frame 19 and cut-out section 117 along bottom side 103 of filter frame 19. The second cut-out 132 includes a cut-out section 114 along front side of filter frame 19 and cut-out section 115 along bottom side 103 of filter frame 19. The third cut-out 143 includes a cut-out section 126 along front side of filter frame 19 and cut-out section 127 along bottom side 103 of filter frame 19. The fourth cut-out 142 comprises a cut-out section 124 along back side 103 of filter frame 19 and cut-out section 125 along bottom side 103 of filter frame 19.

The above HVAC filter 40 including an air filter frame and air filtering material contained therein wherein, if when placed in a housing with bottom surface facing out, cut-outs 132, 143 are configured to receive tension clips 262, 372 extending from opposing sides of a bottom side of a cover of a housing.

The above HVAC filter 40 including an air filter frame and air filtering material contained therein in combination with a housing assembly.

The above HVAC filter 40 including an air filter frame and air filtering material contained therein in combination with a housing assembly wherein the housing assembly includes a cover 310, a bottom side 350 of cover 310 comprising a pair of flanges 352,354 and a pair of tension clips 362, 372. Flange 352 is defined on right side 213 near the front end 211 of cover 310 and flange 362 is defined on left side 211 near the back end 214 of cover 310. Tension clip 362 is defined on left side 212 near front end 211 of cover 310 and flange 372 is defined on left side 212 near back end 213 of cover 310. The above HVAC filter 40 including an air filter frame and air filtering material contained therein in combination with a housing assembly with above flanges and tension clips wherein with air filter 40 inserted into the housing assembly 201 the housing assembly applies a tension force to pair of tension clips 362, 372 on housing assembly 210 so as to force tension clips against left and right side of air filter 40 to clamp the sides of air filter 40 to housing assembly 210 so as to keep air filter 40 from moving laterally within housing assembly 201.

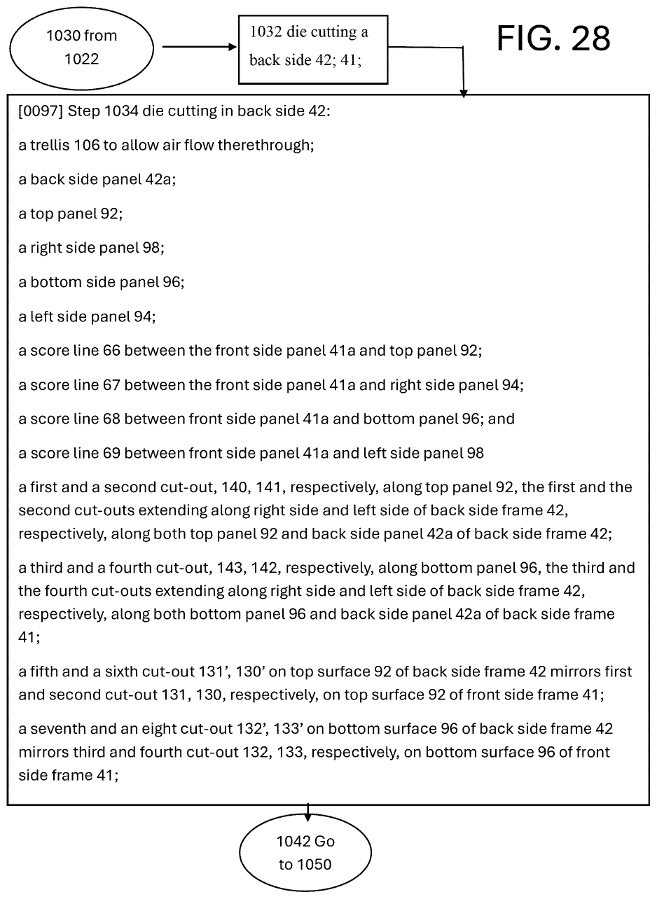

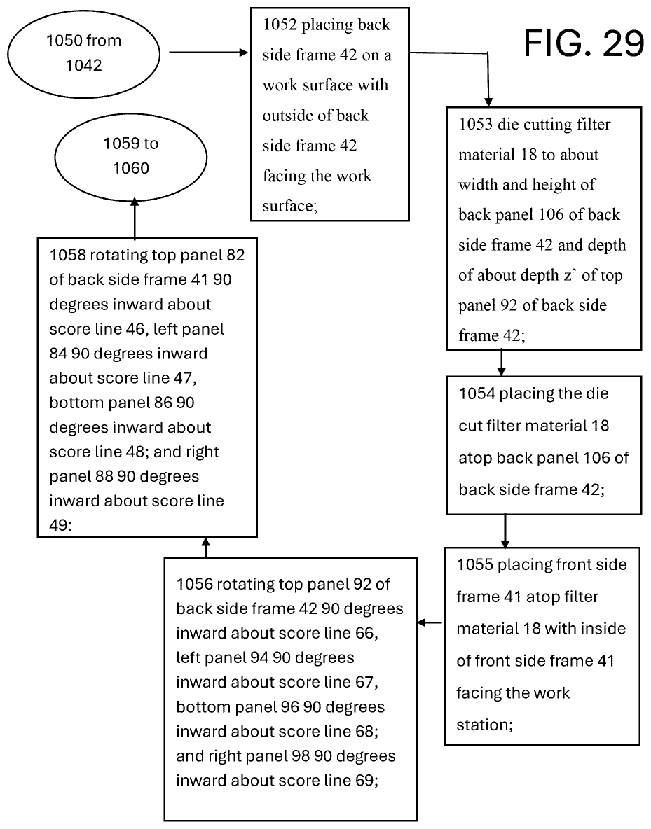

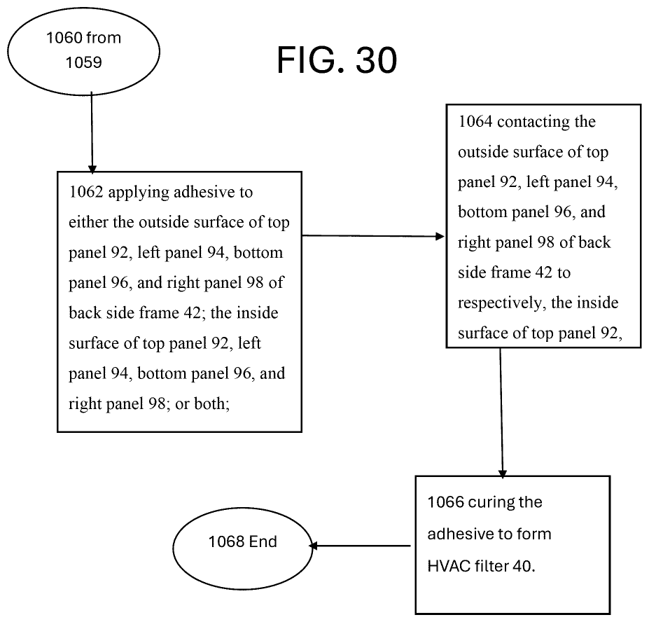

FIGS. 27-30 present a method for making an die cut HVAC filter 40 according to this disclosure with the following steps.

Step 1000 start.

Step 1010 die cutting a front side frame 41.

Step 1011 die cutting in front side frame 41:
a trellis 105 to allow air flow therethrough;
a front side panel 41a;
a top panel 82;
a right side panel 84;
a bottom side panel 86;
a left side panel 88;
a score line 46 between the front side panel 41a and top panel 82;
a score line 47 between the front side panel 41a and right side panel 84;
a score line 48 between front side panel 41a and bottom panel 86; and
a score line 49 between front side panel 41a and left side panel 88
a first and a second cut-out, 130, 131, respectively, along top panel 82, the first and the second cut-outs extending along right side and left side of front side frame 41, respectively, along both top panel 82 and front side panel 41a of front side frame 41;
a third and a fourth cut-out, 133, 132, respectively, along bottom panel 86, the first and the second cut-outs extending along right side and left side of front side frame 41, respectively, along both bottom panel 86 and front side panel 41a of front side frame 41;
a fifth and a sixth cut-out 140′, 141′ on top surface 82 of front side frame mirrors third and fourth cut-out 140, 141, respectively, on top surface 92 of back side frame 42;
a seventh and an eight cut-out 143′, 142′ on bottom surface 86 of front side frame 41 mirrors third and fourth cut-out 143, 142, respectively, on bottom surface 96 of back side frame 42;

Step 1112 go to step 1130.

Step 1130 continues from step 1112.

Step 1132 die cutting a back side 42.

Step 1034 die cutting in back side 42:
a trellis 106 to allow air flow therethrough;
a back side panel 42a;
a top panel 92;
a right side panel 98;
a bottom side panel 96;
a left side panel 94;
a score line 66 between the front side panel 41a and top panel 92;
a score line 67 between the front side panel 41a and right side panel 94;
a score line 68 between front side panel 41a and bottom panel 96; and
a score line 69 between front side panel 41a and left side panel 98
a first and a second cut-out, 140, 141, respectively, along top panel 92, the first and the second cut-outs extending along right side and left side of back side frame 42, respectively, along both top panel 92 and back side panel 42a of back side frame 42;
a third and a fourth cut-out, 143, 142, respectively, along bottom panel 96, the third and the fourth cut-outs extending along right side and left side of back side frame 42, respectively, along both bottom panel 96 and back side panel 42a of back side frame 41;
a fifth and a sixth cut-out 131′, 130′ on top surface 92 of back side frame 42 mirrors first and second cut-out 131, 130, respectively, on top surface 92 of front side frame 41;
a seventh and an eight cut-out 132′, 133′ on bottom surface 96 of back side frame 42 mirrors third and fourth cut-out 132, 133, respectively, on bottom surface 96 of front side frame 41;

Step 1042 go to step 1050.

Step 1050 continues from step 1042.

Step 1052 placing back side frame 42 on a work surface with outside of back side frame 42 facing the work surface;

Step 1053 die cutting filter material 18 to about width and height of back panel 106 of back side frame 42 and depth of about depth z′ of top panel 92 of back side frame 42.

Step 1054 placing the die cut filter material 18 atop back panel 106 of back side frame 42.

Step 1055 placing front side frame 41 atop filter material 18 with inside of front side frame 41 facing the work station.

Step 1056 rotating top panel 92 of back side frame 42 90 degrees inward about score line 66, left panel 94 90 degrees inward about score line 67, bottom panel 96 90 degrees inward about score line 68; and right panel 98 90 degrees inward about score line 69.

Step 1058 rotating top panel 82 of back side frame 41 90 degrees inward about score line 46, left panel 84 90 degrees inward about score line 47, bottom panel 86 90 degrees inward about score line 48; and right panel 88 90 degrees inward about score line 49.

Step 1059 go to step 1060.

Step 1060 continues from step 1059.

Sept 1062 applying adhesive to either the outside surface of top panel 92, left panel 94, bottom panel 96, and right panel 98 of back side frame 42; the inside surface of top panel 92, left panel 94, bottom panel 96, and right panel 98; or both.

Step 1064 contacting the outside surface of top panel 92, left panel 94, bottom panel 96, and right panel 98 of back side frame 42 to respectively, the inside surface of top panel 92, left panel 94, bottom panel 96, and right panel 98; and

Step 1066 curing the adhesive to form HVAC filter 40.

Step 1068 End.

Advantageously, the lateral tension that tension clips 362, 372 depicted in FIG. 12 (262,272 in FIGS. 18-21) provide across front and back sides of air filter, respectively provides an air filter that is rigidly pressed against front side 211 and back side 215 of housing 210 so as to create a tighter interface between front side 41 and back side 42 of air filter 40 and housing 210 so as to prevent air flow between air filter 40 and housing 210 or vibration of the air filter 40 in housing 210. This improves the efficiency of the air filter 40 by forcing more of the air flow across the air filter material 18 as a result of minimizing the flow of air at the air filter 40 to housing 210 interface and reduces fatigue of the air filter 40 from vibration to thereby provide air filter 40 with a longer life.

The tension that pair of flanges 352,354 provide across right and left sides of air filter 40 also presses the front and back sides of the filter against the front and back sides of the housing 210 so as to create a tighter interface between back end of air filter 40 and housing 210 so as to prevent air flow between air filter 40 and housing 210 or vibration of the air filter 40 in housing 210. This may also improve the efficiency of the air filter 40 by forcing more of the air flow across the air filter material 18 as a result of minimizing the flow of air at the air filter 40 to housing 210 interface and reduces fatigue of the air filter 40 from vibration to thereby provide air filter 40 with a longer life.

Advantageously, the lateral tension that tension clips 362, 372 provide across front and back sides and across right and left sides of air filter, respectively, creates a more air tight seal between air filter to housing assembly fit at the air filter 40 to housing assembly 201 interface so as force more of the air flow across the air filter material and minimizing the flow of air at the air filter to housing assembly interface.

In addition, filter 40 may be inserted into housing 201 either top surface 11 or bottom surface 12 first so that the opposing surface of the top surface 11 or bottom surface 12 facing out provides the cutouts for use as herein disclosed. Specifically, in one illustrative embodiment, if when placed in a housing with top surface facing out, cut-outs 131, 141′, and 141 are configured to receive tension clips 362, 372 depicted in FIG. 12 (262,272 in FIGS. 18-21). And if when placed in a housing with bottom surface facing out, cut-outs 133, 143′, and 143 are configured to receive tension clips 362, 372 depicted in FIG. 12 (262,272 in FIGS. 18-21)

While the invention has been described in connection with specific embodiments, it is evident that numerous alternatives, modifications, and variations will be apparent to those skilled in the art within the spirit and scope of the invention described above.

We claim:

1. An HVAC filter including an air filter frame and air filtering material contained therein, the air filter frame comprising:
a top side, a bottom side, a right side, a left side, a front side, and a back side, both front side and back side of air filter defining a trellis, respectively, of shaped openings, the shaped openings formed in the trellis allowing air flow through the openings of the trellis, and across the filtering material;
wherein, along top side of front side of air filter, front side of air filter frame is provided with a first, a second, a third, and a fourth cut-out, respectively; the first and the second cut-outs extending along right side and left side of air filter frame, respectively, along both top side and front side of air filter frame; and the third and the fourth cut-out 1 extending along right side and left side of air filter frame respectively along both top side and back side of air filter frame;
wherein, along bottom side, air filter frame is provided with first, second, third, and fourth cut-outs, respectively; the first and second cut-outs extending along right side and left side of air filter frame, respectively, along both bottom side and front side of air filter frame; and third and fourth cut-outs extending along left side and right side of air filter frame, respectively, along both bottom side and back side of air filter frame;
wherein, both top side and bottom side of air filter frame are configured to be insertable in a housing of an HVAC air filtration system;
wherein the first, the second, the third, and the fourth cut-outs of the top side or the bottom side of air filter frame, whichever is facing outward from the housing once inserted, is configured to receive a tension clip associated with a housing or cover therefor for the purpose of pressing the filter against the housing so as to provide a tight interface between air filter frame and housing.

2. The HVAC filter including an air filter frame and air filtering material contained therein of claim 1,
wherein the first cut-out comprises a cut-out section along front side of filter frame and cut-out section along top side of filter frame, the second cut-out comprises a cut-out section along front side of filter frame and cut-out section along top side of filter frame, the third cut-out comprises a cut-out section along front side of filter frame and cut-out section along back side of filter frame, and the fourth cut-out comprises a cut-out section along front side of filter frame and cut-out section along back side of filter frame.

3. The HVAC filter 40 including an air filter frame and air filtering material contained therein of claim 1,
wherein the first cut-out comprises a cut-out section along front side of filter frame and cut-out section along bottom side of filter frame, the second cut-out comprises a cut-out section along front side of filter frame and cut-out section along bottom side of filter frame, the third cut-out comprises a cut-out section along front side of filter frame and cut-out section along bottom side of filter frame; and the fourth cut-out comprises a cut-out section along back side of filter frame and cut-out section along bottom side of filter frame.

4. The HVAC filter including an air filter frame and air filtering material contained therein of claim 1,
wherein, if when placed in a housing with bottom surface facing out, cut-outs are configured to receive tension clips extending from opposing sides of a bottom side of a cover of a housing.

5. The HVAC filter including an air filter frame and air filtering material contained therein of claim 1 in combination with a housing assembly.

6. The HVAC filter including an air filter frame and air filtering material contained therein in combination with a housing assembly of claim 5 wherein the housing assembly includes a cover, a bottom side of cover comprising a pair of flanges and a pair of tension clips;
wherein, one of the flanges is defined on the right side near the front end of cover and the other of the flanges is defined on the left side near the back end of cover;
wherein, one tension clip is defined on the left side near the front end of the cover and the other tension clip is defined on the left side near the back end of cover.

7. The HVAC filter including an air filter frame and air filtering material contained therein of claim 6 wherein with air filter inserted into the housing assembly the housing assembly applies a tension force to pair of tension clips on housing assembly so as to force tension clips against left and right side of the air filter to clamp the sides of the air filter to the housing assembly so as to keep the air filter from moving laterally within the housing assembly.

8. A method for making an HVAC filter 40 comprising:
die cutting a front side frame;
die cutting in front side frame:
a trellis to allow air flow therethrough;
a front side panel;
a top panel;
a right side panel;
a bottom side panel;
a left side panel;
a score line between the front side panel and top panel;
a score line between the front side panel and right side panel;
a score line between front side panel and bottom panel; and
a score line between front side panel and left side panel
a first and a second cut-out along top panel, the first and the second cut-outs extending along right side and left side of front side frame, respectively, along both top panel and front side panel of front side frame;
a third and a fourth cut-out along bottom panel 86, the first and the second cut-outs extending along right side and left side of front side frame, respectively, along both bottom panel and front side panel of front side frame;
a fifth and a sixth cut-out on top surface of front side frame to mirror third and fourth cut-out, respectively, on top surface of back side frame;
a seventh and an eight cut-out on bottom surface of front side frame to mirror third and fourth cut-out, respectively, on bottom surface of back side frame;
die cutting a back side;
die cutting in back side:
a trellis to allow air flow therethrough;
a back side panel;
a top panel;
a right side panel;
a bottom side panel;
a left side panel;
a score line between the front side panel and top panel;
a score line between the front side panel and right side panel;
a score line between front side panel and bottom panel; and
a score line between front side panel and left side panel 98
a first and a second cut-out along top panel 92, the first and the second cut-outs extending along right side and left side of back side frame, respectively, along both top panel and back side panel of back side frame;
a third and a fourth cut-out along bottom panel, the third and the fourth cut-outs extending along right side and left side of back side frame, respectively, along both bottom panel and back side panel of back side frame;
a fifth and a sixth cut-out on top surface of back side frame to mirror first and second cut-out, respectively, on top surface of front side frame;
a seventh and an eight cut-out on bottom surface of back side frame to mirror third and fourth cut-out, respectively, on bottom surface of front side frame;
placing back side frame on a work surface with outside of back side frame facing the work surface;
die cutting filter material to about width and height of back panel of back side frame and depth of about depth z′ of top panel of back side frame;
placing the die cut filter material 18 atop back panel of back side frame;
placing front side frame atop filter material 18 with inside of front side frame facing the work station;
rotating top panel of back side frame 90 degrees inward about score line 66, left panel 90 degrees inward about score line 67, bottom panel 90 degrees inward about score line 68; and right panel 90 degrees inward about score line 69;
rotating top panel of back side frame 90 degrees inward about score line 46, left panel 90 degrees inward about score line 47, bottom panel 90 degrees inward about score line 48; and right panel 90 degrees inward about score line 49;
applying adhesive to either the outside surface of top panel, left panel, bottom panel, and right panel of back side frame; the inside surface of top panel, left panel, bottom panel, and right panel; or both;
contacting the outside surface of top panel, left panel, bottom panel, and right panel of back side frame, respectively, the inside surface of top panel, left panel, bottom panel, and right panel;
curing the adhesive to form HVAC filter.
